(19) United States
(12) Patent Application Publication
(10) Pub. No.: US 2019/0343082 A1
(43) Pub. Date: Nov. 14, 2019

(54) Wearable Animal Waste Management

(71) Applicant: Daniel Yeboah, JR., Charlotte, NC (US)

(72) Inventor: Daniel Yeboah, JR., Charlotte, NC (US)

(21) Appl. No.: 15/985,983

(22) Filed: May 22, 2018

Related U.S. Application Data
(60) Provisional application No. 62/603,265, filed on May 22, 2017.

(51) Int. Cl. A01K 27/00

(52) U.S. Cl. CPC A01K 27/002; A01K 27/008; A01K 27/006

(57) ABSTRACT

A system including a pet harness device configured to encircle the pet's body and fastened to secure the pet harness device to the pet's body, a waste bag mechanism attached to the pet harness device for collecting pet waste, a front strap component having a front male fastening device, a front female fastening device configured to engage the front male fastening device to generally engage the harness waste device on the pet's body, a waste bag retention tab implement operable for attaching the waste bag mechanism, and a rear length adjustable leg strap implement into engagement with the waste bag retention tab implement, in which the rear length adjustable leg strap implement is configured to keep the waste bag mechanism in place or open whichever body or leg positions the pet may be in.

### CROSS-REFERENCE TO RELATED APPLICATIONS

The present Utility patent application claims priority benefit of the U.S. provisional application for patent Ser. No. 62/603,265 entitled “Hands off pet harness and waste system”, filed on May 22, 2017, under 35 U.S.C. 119(e). The contents of this related provisional application are incorporated herein by reference for all purposes to the extent that such subject matter is not inconsistent herewith or limiting hereof.

### INCORPORATION BY REFERENCE OF SEQUENCE LISTING PROVIDED AS A TEXT FILE

Not applicable.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection by the author thereof. The copyright owner has no objection to the facsimile reproduction by anyone of the patent document or patent disclosure for the purposes of referencing as patent prior art, as it appears in the Patent and Trademark Office, patent file or records, but otherwise reserves all copyright rights whatsoever.

### BACKGROUND OF THE RELEVANT PRIOR ART

One or more embodiments of the invention generally relate to dog waste management. More particularly, certain embodiments of the invention relates to a wearable dog waste management.

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon. By way of educational background, an aspect of the prior art generally useful to be aware of is that dog waste management while dog walking has several common solutions. A dog walker usually purchases their own bags or uses a public bag dispenser and take bags with them to collect any waste themselves. This solution though may require a dog walker to be extra vigilant and then bend over to collect any waste themselves. Commonly another solution is to use tools like brooms to help collect without bending over by sweeping. This solution though would require a dog walker to walk around with a considerable number of large tools. Yet another solution usually carried out is to have a dog waste management system where a dog may wear it with a harness where a waste bag may be attached. This solution though is usually very difficult to create because a bag typically does not stay in place when pets make certain movements, and another common issue is having a bag that stays sufficiently open during all pet movements. Wearable solutions furthermore may need to have specific types of bags available by only one manufacturer, and alternative non-name brand bags may not fit the harness. Furthermore, a wearable system often requires a complicated harness to keep it in place which makes such harnesses expensive to produce.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIGS. 1A, 1B, and 1C illustrate an exemplary dog waste harness, where 1A is a harness being worn, 1B is a view from the front 1C is a side view with a back part on the right, in accordance with an embodiment of the invention;

FIGS. 2A and 2B illustrate an exemplary dog waste harness, where 2A illustrates a flattened-out harness with a concealing cover flap down, 2B illustrates a flattened-out harness with a concealing cover flap lifted, in accordance with an embodiment of the invention;

FIGS. 3A and 3B illustrate an exemplary waste management harness with a waste bag, where FIG. 3A illustrates the harness and attached waste bag, and FIG. 3B illustrates a waste bag, in accordance with an embodiment of the present invention;

FIG. 4 is a flow chart illustrating a method for attaching a waste bag to a harness, in accordance with an embodiment of the present invention.

Unless otherwise indicated illustrations in the figures are not necessarily drawn to scale.

### DETAILED DESCRIPTION OF SOME EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

All words of approximation as used in the present disclosure and claims should be construed to mean “approximate,” rather than “perfect,” and may accordingly be employed as a meaningful modifier to any other word, specified parameter, quantity, quality, or concept. Words of approximation, include, yet are not limited to terms such as “substantial”, “nearly”, “almost”, “about”, “generally”, “largely”, “essentially”, “closely approximate”, etc.

As will be established in some detail below, it is well settled law, as early as 1939, that words of approximation are not indefinite in the claims even when such limits are not defined or specified in the specification.

For example, see Ex parte Mallory, 52 USPQ 297, 297 (Pat. Off. Bd. App. 1941) where the court said “The examiner has held that most of the claims are inaccurate because apparently the laminar film will not be entirely eliminated. The claims specify that the film is “substantially” eliminated and for the intended purpose, it is believed that the slight portion of the film which may remain is negligible. We are of the view, therefore, that the claims may be regarded as sufficiently accurate.”

Note that claims need only “reasonably apprise those skilled in the art” as to their scope to satisfy the definiteness requirement. See Energy Absorption Sys., Inc. v. Roadway Safety Servs., Inc., Civ. App. 96-1264, slip op. at 10 (Fed. Cir. Jul. 3, 1997) (unpublished) Hybridtech v. Monoclonal Antibodies, Inc., 802 F.2d 1367, 1385, 231 USPQ 81, 94 (Fed. Cir. 1986), cert. denied, 480 U.S. 947 (1987). In addition, the use of modifiers in the claim, like “generally” and “substantial,” does not by itself render the claims indefinite. See Seattle Box Co. v. Industrial Crating & Packing, Inc., 731 F.2d 818, 828-29, 221 USPQ 568, 575-76 (Fed. Cir. 1984).

Moreover, the ordinary and customary meaning of terms like “substantially” includes “reasonably close to: nearly, almost, about”, connoting a term of approximation. See In re Frye, Appeal No. 2009-006013, 94 USPQ2d 1072, 1077, 2010 WL 889747 (B.P.A.I. 2010) Depending on its usage, the word “substantially” can denote either language of approximation or language of magnitude. Deering Precision Instruments, L.L.C. v. Vector Distribution Sys., Inc., 347 F.3d 1314, 1323 (Fed. Cir. 2003) (recognizing the “dual ordinary meaning of th[e] term [“substantially”] as connoting a term of approximation or a term of magnitude”). Here, when referring to the “substantially halfway” limitation, the Specification uses the word “approximately” as a substitute for the word “substantially” (Fact 4). (Fact 4). The ordinary meaning of “substantially halfway” is thus reasonably close to or nearly at the midpoint between the forwardmost point of the upper or outsole and the rearwardmost point of the upper or outsole.

Similarly, the term ‘substantially’ is well recognize in case law to have the dual ordinary meaning of connoting a term of approximation or a term of magnitude. See Dana Corp. v. American Axle & Manufacturing, Inc., Civ. App. 04-1116, 2004 U.S. App. LEXIS 18265, *13-14 (Fed. Cir. Aug. 27, 2004) (unpublished). The term “substantially” is commonly used by claim drafters to indicate approximation. See Cordis Corp. v. Medtronic AVE Inc., 339 F.3d 1352, 1360 (Fed. Cir. 2003) (“The patents do not set out any numerical standard by which to determine whether the thickness of the wall surface is ‘substantially uniform.’ The term ‘substantially,’ as used in this context, denotes approximation. Thus, the walls must be of largely or approximately uniform thickness.”); see also Deering Precision Instruments, LLC v. Vector Distribution Sys., Inc., 347 F.3d 1314, 1322 (Fed. Cir. 2003); Epcon Gas Sys., Inc. v. Bauer Compressors, Inc., 279 F.3d 1022, 1031 (Fed. Cir. 2002). We find that the term “substantially” was used in just such a manner in the claims of the patents-in-suit: “substantially uniform wall thickness” denotes a wall thickness with approximate uniformity.

It should also be noted that such words of approximation as contemplated in the foregoing clearly limits the scope of claims such as saying ‘generally parallel’ such that the adverb ‘generally’ does not broaden the meaning of parallel. Accordingly, it is well settled that such words of approximation as contemplated in the foregoing (e.g., like the phrase ‘generally parallel’) envisions some amount of deviation from perfection (e.g., not exactly parallel), and that such words of approximation as contemplated in the foregoing are descriptive terms commonly used in patent claims to avoid a strict numerical boundary to the specified parameter. To the extent that the plain language of the claims relying on such words of approximation as contemplated in the foregoing are clear and uncontradicted by anything in the written description herein or the figures thereof, it is improper to rely upon the present written description, the figures, or the prosecution history to add limitations to any of the claim of the present invention with respect to such words of approximation as contemplated in the foregoing. That is, under such circumstances, relying on the written description and prosecution history to reject the ordinary and customary meanings of the words themselves is impermissible. See, for example, Liquid Dynamics Corp. v. Vaughan Co., 355 F.3d 1361, 69 USPQ2d 1595, 1600-01 (Fed. Cir. 2004). The plain language of phrase 2 requires a “substantial helical flow.” The term “substantial” is a meaningful modifier implying “approximate,” rather than “perfect.” In Cordis Corp. v. Medtronic AVE, Inc., 339 F.3d 1352, 1361 (Fed. Cir. 2003), the district court imposed a precise numeric constraint on the term “substantially uniform thickness.” We noted that the proper interpretation of this term was “of largely or approximately uniform thickness” unless something in the prosecution history imposed the “clear and unmistakable disclaimer” needed for narrowing beyond this simple-language interpretation. Id. In Anchor Wall Systems v. Rockwood Retaining Walls, Inc., 340 F.3d 1298, 1311 (Fed. Cir. 2003)” Id. at 1311. Similarly, the plain language of claim 1 requires neither a perfectly helical flow nor a flow that returns precisely to the center after one rotation (a limitation that arises only as a logical consequence of requiring a perfectly helical flow).

The reader should appreciate that case law generally recognizes a dual ordinary meaning of such words of approximation, as contemplated in the foregoing, as connoting a term of approximation or a term of magnitude; e.g., see Deering Precision Instruments, L.L.C. v. Vector Distrib. Sys., Inc., 347 F.3d 1314, 68 USPQ2d 1716, 1721 (Fed. Cir. 2003), cert. denied, 124 S. Ct. 1426 (2004) where the court was asked to construe the meaning of the term “substantially” in a patent claim. Also see Epcon, 279 F.3d at 1031 (“The phrase ‘substantially constant’ denotes language of approximation, while the phrase ‘substantially below’ signifies language of magnitude, i.e., not insubstantial.”). Also, see, e.g., Epcon Gas Sys., Inc. v. Bauer Compressors, Inc., 279 F.3d 1022 (Fed. Cir. 2002) (construing the terms “substantially constant” and “substantially below”); Zodiac Pool Care, Inc. v. Hoffinger Indus., Inc., 206 F.3d 1408 (Fed. Cir. 2000) (construing the term “substantially inward”); York Prods., Inc. v. Cent. Tractor Farm & Family Ctr., 99 F.3d 1568 (Fed. Cir. 1996) (construing the term “substantially the entire height thereof”); Tex. Instruments Inc. v. Cypress Semiconductor Corp., 90 F.3d 1558 (Fed. Cir. 1996) (construing the term “substantially in the common plane”). In conducting their analysis, the court instructed to begin with the ordinary meaning of the claim terms to one of ordinary skill in the art. Prima Tek, 318 F.3d at 1148. Reference to dictionaries and our cases indicates that the term “substantially” has numerous ordinary meanings. As the district court stated, “substantially” can mean “significantly” or “considerably.” The term “substantially” can also mean “largely” or “essentially.” Webster's New 20th Century Dictionary 1817 (1983).

Words of approximation, as contemplated in the foregoing, may also be used in phrases establishing approximate ranges or limits, where the end points are inclusive and approximate, not perfect; e.g., see AK Steel Corp. v. Sollac, 344 F.3d 1234, 68 USPQ2d 1280, 1285 (Fed. Cir. 2003) where it where the court said [W]e conclude that the ordinary meaning of the phrase “up to about 10%” includes the “about 10%” endpoint. As pointed out by AK Steel, when an object of the preposition “up to” is nonnumeric, the most natural meaning is to exclude the object (e.g., painting the wall up to the door). On the other hand, as pointed out by Sollac, when the object is a numerical limit, the normal meaning is to include that upper numerical limit (e.g., counting up to ten, seating capacity for up to seven passengers). Because we have here a numerical limit—“about 10%”—the ordinary meaning is that that endpoint is included.

In the present specification and claims, a goal of employment of such words of approximation, as contemplated in the foregoing, is to avoid a strict numerical boundary to the modified specified parameter, as sanctioned by Pall Corp. v. Micron Separations, Inc., 66 F.3d 1211, 1217, 36 USPQ2d 1225, 1229 (Fed. Cir. 1995) where it states “It is well established that when the term “substantially” serves reasonably to describe the subject matter so that its scope would be understood by persons in the field of the invention, and to distinguish the claimed subject matter from the prior art, it is not indefinite.” Likewise see Verve LLC v. Crane Cams Inc., 311 F.3d 1116, 65 USPQ2d 1051, 1054 (Fed. Cir. 2002). Expressions such as “substantially” are used in patent documents when warranted by the nature of the invention, in order to accommodate the minor variations that may be appropriate to secure the invention. Such usage may well satisfy the charge to “particularly point out and distinctly claim” the invention, 35 U.S.C. § 112, and indeed may be necessary in order to provide the inventor with the benefit of his invention. In Andrew Corp. v. Gabriel Elecs. Inc., 847 F.2d 819, 821-22, 6 USPQ2d 2010, 2013 (Fed. Cir. 1988) the court explained that usages such as “substantially equal” and “closely approximate” may serve to describe the invention with precision appropriate to the technology and without intruding on the prior art. The court again explained in Ecolab Inc. v. Envirochem, Inc., 264 F.3d 1358, 1367, 60 USPQ2d 1173, 1179 (Fed. Cir. 2001) that “like the term ‘about,’ the term ‘substantially’ is a descriptive term commonly used in patent claims to ‘avoid a strict numerical boundary to the specified parameter, see Ecolab Inc. v. Envirochem Inc., 264 F.3d 1358, 60 USPQ2d 1173, 1179 (Fed. Cir. 2001) where the court found that the use of the term “substantially” to modify the term “uniform” does not render this phrase so unclear such that there is no means by which to ascertain the claim scope.

Similarly, other courts have noted that like the term “about,” the term “substantially” is a descriptive term commonly used in patent claims to “avoid a strict numerical boundary to the specified parameter.”; e.g., see Pall Corp. v. Micron Seps., 66 F.3d 1211, 1217, 36 USPQ2d 1225, 1229 (Fed. Cir. 1995); see, e.g., Andrew Corp. v. Gabriel Elecs. Inc., 847 F.2d 819, 821-22, 6 USPQ2d 2010, 2013 (Fed. Cir. 1988) (noting that terms such as “approach each other,” “close to,” “substantially equal,” and “closely approximate” are ubiquitously used in patent claims and that such usages, when serving reasonably to describe the claimed subject matter to those of skill in the field of the invention, and to distinguish the claimed subject matter from the prior art, have been accepted in patent examination and upheld by the courts). In this case, “substantially” avoids the strict 100% nonuniformity boundary.

Indeed, the foregoing sanctioning of such words of approximation, as contemplated in the foregoing, has been established as early as 1939, see Ex parte Mallory, 52 USPQ 297, 297 (Pat. Off. Bd. App. 1941) where, for example, the court said “the claims specify that the film is “substantially” eliminated and for the intended purpose, it is believed that the slight portion of the film which may remain is negligible. We are of the view, therefore, that the claims may be regarded as sufficiently accurate.” Similarly, In re Hutchison, 104 F.2d 829, 42 USPQ 90, 93 (C.C.P.A. 1939) the court said “It is realized that “substantial distance” is a relative and somewhat indefinite term, or phrase, but terms and phrases of this character are not uncommon in patents in cases where, according to the art involved, the meaning can be determined with reasonable clearness.”

Hence, for at least the forgoing reason, Applicants submit that it is improper for any examiner to hold as indefinite any claims of the present patent that employ any words of approximation.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will be described in detail below with reference to embodiments thereof as illustrated in the accompanying drawings.

References to a “device,” an “apparatus,” a “system,” etc., in the preamble of a claim should be construed broadly to mean “any structure meeting the claim terms” exempt for any specific structure(s)/type(s) that has/(have) been explicitly disavowed or excluded or admitted/implied as prior art in the present specification or incapable of enabling an object/aspect/goal of the invention. Furthermore, where the present specification discloses an object, aspect, function, goal, result, or advantage of the invention that a specific prior art structure and/or method step is similarly capable of performing yet in a very different way, the present invention disclosure is intended to and shall also implicitly include and cover additional corresponding alternative embodiments that are otherwise identical to that explicitly disclosed except that they exclude such prior art structure(s)/step(s), and shall accordingly be deemed as providing sufficient disclosure to support a corresponding negative limitation in a claim claiming such alternative embodiment(s), which exclude such very different prior art structure(s)/step(s) way(s).

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” “some embodiments,” “embodiments of the invention,” etc., may indicate that the embodiment(s) of the invention so described may include a particular feature, structure, or characteristic, but not every possible embodiment of the invention necessarily includes the particular feature, structure, or characteristic. Further, repeated use of the phrase “in one embodiment,” or “in an exemplary embodiment,” “an embodiment,” do not necessarily refer to the same embodiment, although they may. Moreover, any use of phrases like “embodiments” in connection with “the invention” are never meant to characterize that all embodiments of the invention must include the particular feature, structure, or characteristic, and should instead be understood to mean “at least some embodiments of the invention” include the stated particular feature, structure, or characteristic.

References to “user”, or any similar term, as used herein, may mean a human or non-human user thereof. Moreover, “user”, or any similar term, as used herein, unless expressly stipulated otherwise, is contemplated to mean users at any stage of the usage process, to include, without limitation, direct user(s), intermediate user(s), indirect user(s), and end user(s). The meaning of “user”, or any similar term, as used herein, should not be otherwise inferred or induced by any pattern(s) of description, embodiments, examples, or referenced prior-art that may (or may not) be provided in the present patent.

References to “end user”, or any similar term, as used herein, is generally intended to mean late stage user(s) as opposed to early stage user(s). Hence, it is contemplated that there may be a multiplicity of different types of “end user” near the end stage of the usage process. Where applicable, especially with respect to distribution channels of embodiments of the invention comprising consumed retail products/services thereof (as opposed to sellers/vendors or Original Equipment Manufacturers), examples of an “end user” may include, without limitation, a “consumer”, “buyer”, “customer”, “purchaser”, “shopper”, “enjoyer”, “viewer”, or individual person or non-human thing benefiting in any way, directly or indirectly, from use of or interaction, with some aspect of the present invention.

In some situations, some embodiments of the present invention may provide beneficial usage to more than one stage or type of usage in the foregoing usage process. In such cases where multiple embodiments targeting various stages of the usage process are described, references to “end user”, or any similar term, as used therein, are generally intended to not include the user that is the furthest removed, in the foregoing usage process, from the final user therein of an embodiment of the present invention.

Where applicable, especially with respect to retail distribution channels of embodiments of the invention, intermediate user(s) may include, without limitation, any individual person or non-human thing benefiting in any way, directly or indirectly, from use of, or interaction with, some aspect of the present invention with respect to selling, vending, Original Equipment Manufacturing, marketing, merchandising, distributing, service providing, and the like thereof.

References to “person”, “individual”, “human”, “a party”, “animal”, “creature”, or any similar term, as used herein, even if the context or particular embodiment implies living user, maker, or participant, it should be understood that such characterizations are sole by way of example, and not limitation, in that it is contemplated that any such usage, making, or participation by a living entity in connection with making, using, and/or participating, in any way, with embodiments of the present invention may be substituted by such similar performed by a suitably configured non-living entity, to include, without limitation, automated machines, robots, humanoids, computational systems, information processing systems, artificially intelligent systems, and the like. It is further contemplated that those skilled in the art will readily recognize the practical situations where such living makers, users, and/or participants with embodiments of the present invention may be in whole, or in part, replaced with such non-living makers, users, and/or participants with embodiments of the present invention. Likewise, when those skilled in the art identify such practical situations where such living makers, users, and/or participants with embodiments of the present invention may be in whole, or in part, replaced with such non-living makers, it will be readily apparent in light of the teachings of the present invention how to adapt the described embodiments to be suitable for such non-living makers, users, and/or participants with embodiments of the present invention. Thus, the invention is thus to also cover all such modifications, equivalents, and alternatives falling within the spirit and scope of such adaptations and modifications, at least in part, for such non-living entities.

Headings provided herein are for convenience and are not to be taken as limiting the disclosure in any way.

The enumerated listing of items does not imply that any or all of the items are mutually exclusive, unless expressly specified otherwise.

It is understood that the use of specific component, device and/or parameter names are for example only and not meant to imply any limitations on the invention. The invention may thus be implemented with different nomenclature/terminology utilized to describe the mechanisms/units/structures/components/devices/parameters herein, without limitation. Each term utilized herein is to be given its broadest interpretation given the context in which that term is utilized.

Terminology. The following paragraphs provide definitions and/or context for terms found in this disclosure (including the appended claims):

“Comprising.” This term is open-ended. As used in the appended claims, this term does not foreclose additional structure or steps. Consider a claim that recites: “A memory controller comprising a system cache . . . .” Such a claim does not foreclose the memory controller from including additional components (e.g., a memory channel unit, a switch).

“Configured To.” Various units, circuits, or other components may be described or claimed as “configured to” perform a task or tasks. In such contexts, “configured to” or “operable for” is used to connote structure by indicating that the mechanisms/units/circuits/components include structure (e.g., circuitry and/or mechanisms) that performs the task or tasks during operation. As such, the mechanisms/unit/circuit/component can be said to be configured to (or be operable) for perform(ing) the task even when the specified mechanisms/unit/circuit/component is not currently operational (e.g., is not on). The mechanisms/units/circuits/components used with the “configured to” or “operable for” language include hardware—for example, mechanisms, structures, electronics, circuits, memory storing program instructions executable to implement the operation, etc. Reciting that a mechanism/unit/circuit/component is “configured to” or “operable for” perform(ing) one or more tasks is expressly intended not to invoke 35 U.S.C. .sctn.112, sixth paragraph, for that mechanism/unit/circuit/component. “Configured to” may also include adapting a manufacturing process to fabricate devices or components that are adapted to implement or perform one or more tasks.

“Based On.” As used herein, this term is used to describe one or more factors that affect a determination. This term does not foreclose additional factors that may affect a determination. That is, a determination may be solely based on those factors or based, at least in part, on those factors. Consider the phrase “determine A based on B.” While B may be a factor that affects the determination of A, such a phrase does not foreclose the determination of A from also being based on C. In other instances, A may be determined based solely on B.

The terms “a”, “an” and “the” mean “one or more”, unless expressly specified otherwise.

Unless otherwise indicated, all numbers expressing conditions, concentrations, dimensions, and so forth used in the specification and claims are to be understood as being modified in all instances by the term “about.” Accordingly, unless indicated to the contrary, the numerical parameters set forth in the following specification and attached claims are approximations that may vary depending at least upon a specific analytical technique.

The term “comprising,” which is synonymous with “including,” “containing,” or “characterized by” is inclusive or open-ended and does not exclude additional, unrecited elements or method steps. “Comprising” is a term of art used in claim language which means that the named claim elements are essential, but other claim elements may be added and still form a construct within the scope of the claim.

As used herein, the phase “consisting of” excludes any element, step, or ingredient not specified in the claim. When the phrase “consists of” (or variations thereof) appears in a clause of the body of a claim, rather than immediately following the preamble, it limits only the element set forth in that clause; other elements are not excluded from the claim as a whole. As used herein, the phase “consisting essentially of” and “consisting of” limits the scope of a claim to the specified elements or method steps, plus those that do not materially affect the basis and novel characteristic(s) of the claimed subject matter (see Norian Corp. v Stryker Corp., 363 F.3d 1321, 1331-32, 70 USPQ2d 1508, Fed. Cir. 2004). Moreover, for any claim of the present invention which claims an embodiment “consisting essentially of” or “consisting of” a certain set of elements of any herein described embodiment it shall be understood as obvious by those skilled in the art that the present invention also covers all possible varying scope variants of any described embodiment(s) that are each exclusively (i.e., “consisting essentially of”) functional subsets or functional combination thereof such that each of these plurality of exclusive varying scope variants each consists essentially of any functional subset(s) and/or functional combination(s) of any set of elements of any described embodiment(s) to the exclusion of any others not set forth therein. That is, it is contemplated that it will be obvious to those skilled how to create a multiplicity of alternate embodiments of the present invention that simply consisting essentially of a certain functional combination of elements of any described embodiment(s) to the exclusion of any others not set forth therein, and the invention thus covers all such exclusive embodiments as if they were each described herein.

With respect to the terms “comprising,” “consisting of,” and “consisting essentially of,” where one of these three terms is used herein, the disclosed and claimed subject matter may include the use of either of the other two terms. Thus in some embodiments not otherwise explicitly recited, any instance of “comprising” may be replaced by “consisting of” or, alternatively, by “consisting essentially of”, and thus, for the purposes of claim support and construction for “consisting of” format claims, such replacements operate to create yet other alternative embodiments “consisting essentially of” only the elements recited in the original “comprising” embodiment to the exclusion of all other elements.

Moreover, any claim limitation phrased in functional limitation terms covered by 35 USC § 112(6) (post AIA 112(f)) which has a preamble invoking the closed terms “consisting of,” or “consisting essentially of,” should be understood to mean that the corresponding structure(s) disclosed herein define the exact metes and bounds of what the so claimed invention embodiment(s) consists of, or consisting essentially of, to the exclusion of any other elements which do not materially affect the intended purpose of the so claimed embodiment(s).

Devices or system modules that are in at least general communication with each other need not be in continuous communication with each other, unless expressly specified otherwise. In addition, devices or system modules that are in at least general communication with each other may communicate directly or indirectly through one or more intermediaries. Moreover, it is understood that any system components described or named in any embodiment or claimed herein may be grouped or sub-grouped (and accordingly implicitly renamed) in any combination or sub-combination as those skilled in the art can imagine as suitable for the particular application, and still be within the scope and spirit of the claimed embodiments of the present invention. For an example of what this means, if the invention was a controller of a motor and a valve and the embodiments and claims articulated those components as being separately grouped and connected, applying the foregoing would mean that such an invention and claims would also implicitly cover the valve being grouped inside the motor and the controller being a remote controller with no direct physical connection to the motor or internalized valve, as such the claimed invention is contemplated to cover all ways of grouping and/or adding of intermediate components or systems that still substantially achieve the intended result of the invention.

A description of an embodiment with several components in communication with each other does not imply that all such components are required. On the contrary a variety of optional components are described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

It is to be understood that any exact measurements/dimensions or particular construction materials indicated herein are solely provided as examples of suitable configurations and are not intended to be limiting in any way. Depending on the needs of the particular application, those skilled in the art will readily recognize, in light of the following teachings, a multiplicity of suitable alternative implementation details.

An embodiment of the present invention may provide an improved dog waste management harness system, a hands-free way to collect and dispose of dog waste in a concealed resealable (Ziploc© type of) bag. A re-sealable bag may be placed on a wearable harness around a dog's anus in an open position ready to collect waste. Furthermore, this harness system may also additionally be adaptable to use with a variety of re-sealable bags, both generic and name brand. The disposable waste bags may vary in size to accommodate pets in various sizes, such as but not limited to, extra small, small, medium, large and extra large. In an embodiment bags may range from approximately 5 inches×5 inches to 7 inches×7 inches, but may alternatively have any dimension varied.

Compared to prior art, this wearable waste self-collection system may have a simplified and more secure bag placement technique. This technique may allow a dog to be in any position or angle or movement and a bag may stay in place. A harness piece which may hold a bag in place using leg straps, may be auto adjusting. A waste bag design may feature a semi-rigid re-sealable lining near its opening. This lining may help keep a bag fully open when attached to a harness and to seal a waste bag in a closed position after pet's waste has been deposited in a waste bag. An auto-adjusting system may use a plurality of leg straps which may pin a waste bag under an anus under a tail, this may help keep a bag properly positioned and ready to receive waste no matter what body or legs positions a dog may be in. Furthermore, compared to prior art, this system is simpler and therefore less expensive to manufacture. In an exemplary embodiment attachment of a waste bag may be achieved in numerous ways including but not limited to: 1. Semi-rigid components made of materials including but not limited to plastic, fabric, metal, or other materials may be sewn in or otherwise attached to a harness which may allow a waste bag to be stretched over so that it may be secured to a harness in an open position. 2. Various fastening methods (including but not limited to magnets, adhesive, clips, snaps, and buttons) may be positioned in and around an area of an animal's rectum which may allow attachment of a waste bag. 3. Electro-mechanical mechanism capable of expansion and/or retraction may be used to open and retain a bag. 4. Alternatively, two mating components may have features including but not limited to, components for attaching to a harness which may be designed to entrap a waste bag in an open position. 5. Alternatively, a permanent and non-disposable receptacle may be attached to a harness which may serve to receive a disposable waste bag so that a disposable waste bag may be placed in an open position and may be removed or replaced after use. 6. Alternatively, a harness may be designed with a plurality of fasteners positioned and activated which may form an aperture that may be expanded or retracted manually to open or close a bag.

A dog waste harness may have a wider area on top for optional storage, so a dog walker may store additional bags. A harness may have an extra amount of fabric in a back area on top for concealing a waste bag. A harness may also be produced in various sizes for various sized dogs. Alternative embodiments for a harness waste system may include but are not limited to: different materials, sizes, and interconnections may be used for all components, in lieu of hook and loop closures, snaps, buttons, press fit or snap features, magnets, adhesive, or clips may be used to attach a waste bag to a harness, a permanent waste bag with a removable liner may be sewn to a harness, a one-piece harness or a multi piece garment or a system of straps may be used, a waste bag may then be attached using various attachment schemes, or a harness may have a separate (or detachable) waste bag cover.

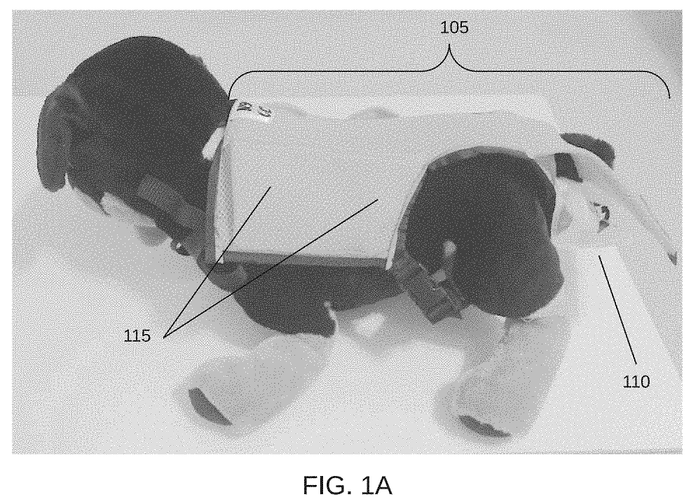

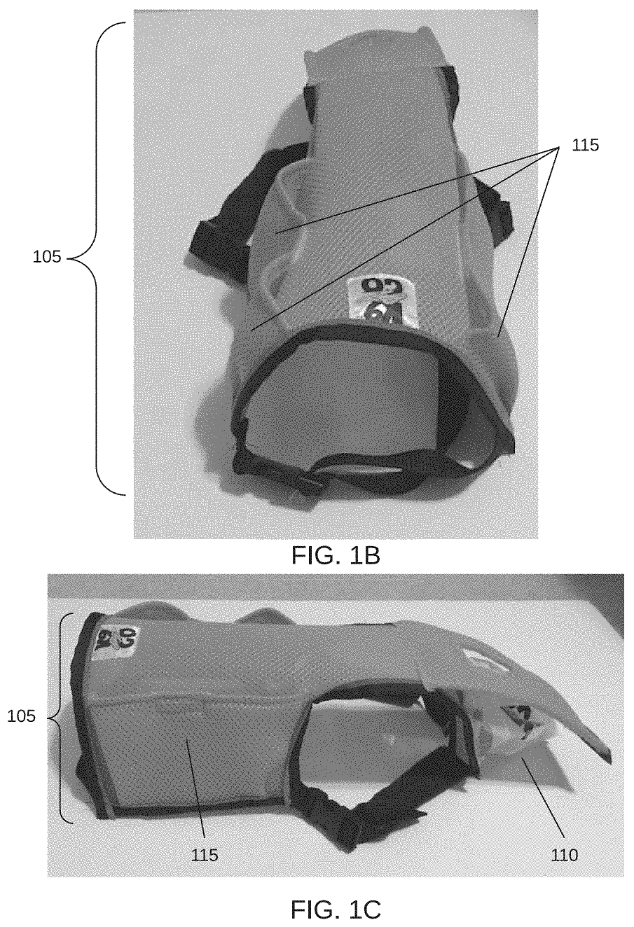

FIGS. 1A, 1B, and 1C illustrate an exemplary dog waste harness, where 1A is a harness being worn, 1B is a view from the front 1C is a side view with a back part on the right, in accordance with an embodiment of the invention. A dog harness 105 may be made from materials such as but not limited to a breathable nylon blend or mesh material. Alternatively, a harness may be constructed from various materials including but not limited to woven, knitted, or felt fabric types. A cooling or heating system may be incorporated into a harness to control a pet's body temperature. Alternatively, a harness may be constructed of materials including but not limited to those capable of conditioning to a set temperature and maintaining a set temperature. Alternatively, a harness may be wholly or partially constructed from materials including but not limited to molded plastic with a plurality of straps for attachments. Alternatively, a harness may be constructed from materials including but not limited to a form fitting compressive material eliminating or minimizing use of straps for attachment to a pet. A harness waste system 105 may have an attached bag made from materials including but not limited to plastic biodegradable materials 110 on a pet. Alternatively, exemplary embodiments may use either a disposable on reusable waste bags. Bags may be constructed with materials including but not limited to biodegradable or non-biodegradable materials. Waste bags may be constructed from various materials including but not limited to paper, plastic, fabric, and metal. A harness may also have additional bags and pockets 115. A harness may also include additional features including but not limited to: 1. Attachment of commercially available dog walking accessories including but not limited to leashes. 2. GPS tracking devices which may determine a pet's location. 3. Systems which may control pet behavior. 4. Reflective materials which may provide visibility in the dark.

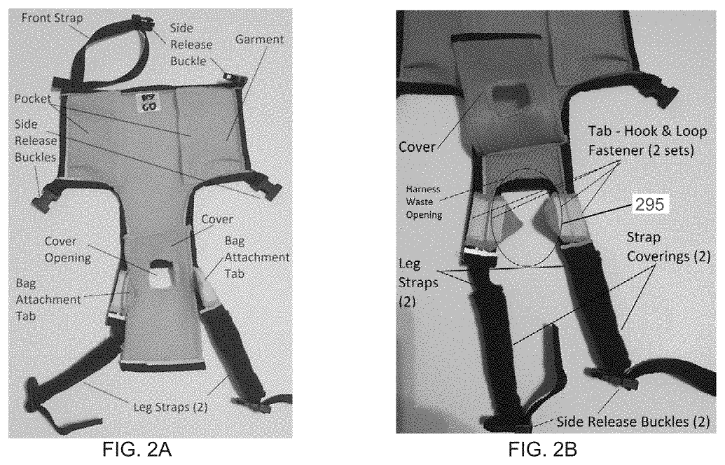

FIGS. 2A and 2B illustrate an exemplary dog waste harness, where 2A illustrates a flattened-out harness with a concealing cover flap down, 2B illustrates a flattened-out harness with a concealing cover flap lifted, in accordance with an embodiment of the invention. FIGS. 2A and 2B are close up partial views of waste bag attachment features of a harness waste system. A harness waste opening area 295 may be alternatively oval or any other suitable shape. Waste bag retention tabs may be part of a harness waste system and made of a same material. Waste bag retention tabs may be located in a harness opening near a top of said opening. Rear straps may attach using hook and loop (Velcro© like) fasteners. Rear straps may have loop closure attached. A rear strap with loop closure may be pulled between a pet's legs and along a pet upper right leg and attach to a rear strap hook closure. Rear strap closure may be attached to harness waste system. A rear strap with loop closure may be pulled between a pet's legs and along a pet's upper left leg and attached to hook closure. An exemplary embodiment may use accessories including but not limited to commercially available side release buckles to attach front and rear straps. Alternatively, various fastening methods may be used including but not limited to buttons, clips, and adhesives. Rear straps may be made of materials including but not limited to elastic webbing material to ensure a snug, comfortable fit and ease of movement for a pet. Alternatively, any material with elastic property that may change length or size when a force may be applied may be used. A leash and storage buckle may be used to attach a leash to a harness waste system or store it by hanging on a hanger. Once a harness waste system may be on a pet's back, a front strap may then be pulled around a pet's frontal chest area and a male side release buckle may be snapped into a female side release buckle. A harness may be constructed of materials including but not limited to form fitting compressive materials which may not require use of a strap for attachment to a pet. Alternatively, a harness may be so designed to encircle a pet's body and fastened to keep closed, where means of fastening may include but are not limited to magnets, clips, buttons or snaps.

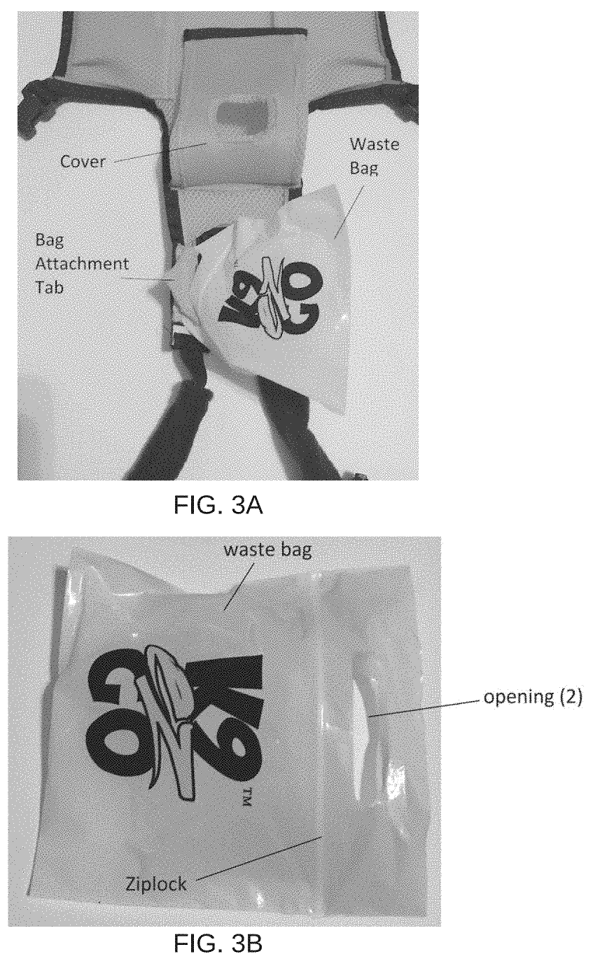

FIGS. 3A and 3B illustrate an exemplary waste management harness with a waste bag, where FIG. 3A illustrates the harness and attached waste bag, and FIG. 3B illustrates a waste bag, in accordance with an embodiment of the present invention. A harness piece which may hold a bag in place using leg straps, may be auto adjusting. An auto-adjusting system may use a plurality of leg straps which may pin a waste bag under an anus under a tail, this may help keep it open no matter what body or legs positions a dog may be in. Waste bags may have two slot (or slit) openings, one each on opposite sides of a bag, near a top of a bag opening. A waste bag design may feature a semi-rigid re-sealable lining near its opening. This lining may help keep a bag fully open when attached to a harness to seal a waste bag in a closed position after pet's waste has been deposited in a waste bag. Alternative means to attach a bag in an initial open or subsequent open position may include but are not limited to: 1. Semi-rigid component made of materials including but not limited to plastic, fabric, metal, or other materials may be sewn or otherwise attached to a harness which may allow a waste bag to be stretched over so that it may be secured to a harness in an open position. 2. Various fastening methods may be positioned in and around an area of an animal's rectum to allow attachment of a waste bag, including but not limited to, magnets, adhesive, clips, snaps, buttons. 3. Electro-mechanical mechanisms capable of expansion and/or retraction may be used to open and retain a bag. 4. Alternatively, two mating components with features to attach to a harness may be designed that entrap a waste bag in an open position. 5. Alternatively, a permanent non-disposable receptacle may be attached to a harness which may serve to receive a disposable waste bag so that a disposable waste bag may be placed in an open position and removed or replaced after use. 6. Alternatively, a harness may be designed with a plurality of fasteners positioned and activated to form an aperture which may be expanded or retracted manually to open or close the bag. A waste bag may first be attached to a harness waste system, prior to placing it on a pet. A waste bag may be attached in an open position over a harness waste system opening using bag retention tabs. Hook closure and loop closure may both attach to a bag retention tab, which may form a singular mating attachment/detachment mechanism. Correspondingly, hook closure and loop closure may be mounted to a bag retention tab, which may form a singular mating attachment/detachment mechanism. Alternative methods to close a bag retention tab may include but are not limited to: buttons, snaps, adhesive, magnets, ties.

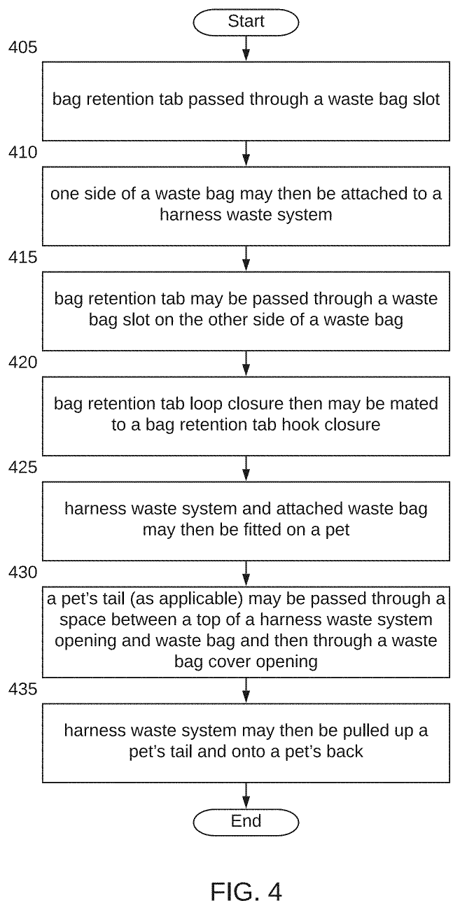

FIG. 4 is a flow chart illustrating a method for attaching a waste bag to a harness, in accordance with an embodiment of the present invention. An exemplary standard process for attaching a waste bag to a harness waste system may include a Step 405 where a bag retention tab may be passed through a waste bag slot. In a Step 410 one side of a waste bag may then be attached to a harness waste system by mating loop closure of a bag retention tab to hook closure to partially secure a waste bag. A retention tab may then be closed via a hook and loop closure thus one side of a waste bag may then be attached to the harness waste system. In a Step 415 correspondingly, a bag retention tab may be passed through a waste bag slot on the other side of a waste bag. In a Step 420 a bag retention tab loop closure then may be mated to a bag retention tab hook closure to fully attach a waste bag in a fully open position. In a Step 425 a harness waste system and attached waste bag may then be fitted on a pet. In a Step 430 a pet's tail (as applicable) may be passed through a space between a top of a harness waste system opening and waste bag and then through a waste bag cover opening. In a Step 435 a harness waste system may then be pulled up a pet's tail and onto a pet's back.

Those skilled in the art will readily recognize, in light of and in accordance with the teachings of the present invention, that any of the foregoing steps may be suitably replaced, reordered, removed and additional steps may be inserted depending upon the needs of the particular application. Moreover, the prescribed method steps of the foregoing embodiments may be implemented using any physical and/or hardware system that those skilled in the art will readily know is suitable in light of the foregoing teachings. For any method steps described in the present application that can be carried out on a computing machine, a typical computer system can, when appropriately configured or designed, serve as a computer system in which those aspects of the invention may be embodied.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

It is noted that according to USA law 35 USC § 112 (1), all claims must be supported by sufficient disclosure in the present patent specification, and any material known to those skilled in the art need not be explicitly disclosed. However, 35 USC § 112 (6) requires that structures corresponding to functional limitations interpreted under 35 USC § 112 (6) must be explicitly disclosed in the patent specification. Moreover, the USPTO's Examination policy of initially treating and searching prior art under the broadest interpretation of a “mean for” or “steps for” claim limitation implies that the broadest initial search on 35 USC § 112(6) (post AIA 112(f)) functional limitation would have to be conducted to support a legally valid Examination on that USPTO policy for broadest interpretation of “mean for” claims. Accordingly, the USPTO will have discovered a multiplicity of prior art documents including disclosure of specific structures and elements which are suitable to act as corresponding structures to satisfy all functional limitations in the below claims that are interpreted under 35 USC § 112(6) (post AIA 112(f)) when such corresponding structures are not explicitly disclosed in the foregoing patent specification. Therefore, for any invention element(s)/structure(s) corresponding to functional claim limitation(s), in the below claims interpreted under 35 USC § 112(6) (post AIA 112(f)), which is/are not explicitly disclosed in the foregoing patent specification, yet do exist in the patent and/or non-patent documents found during the course of USPTO searching, Applicant(s) incorporate all such functionally corresponding structures and related enabling material herein by reference for the purpose of providing explicit structures that implement the functional means claimed. Applicant(s) request(s) that fact finders during any claims construction proceedings and/or examination of patent allowability properly identify and incorporate only the portions of each of these documents discovered during the broadest interpretation search of 35 USC § 112(6) (post AIA 112(f)) limitation, which exist in at least one of the patent and/or non-patent documents found during the course of normal USPTO searching and or supplied to the USPTO during prosecution. Applicant(s) also incorporate by reference the bibliographic citation information to identify all such documents comprising functionally corresponding structures and related enabling material as listed in any PTO Form-892 or likewise any information disclosure statements (IDS) entered into the present patent application by the USPTO or Applicant(s) or any 3^{rd} parties. Applicant(s) also reserve its right to later amend the present application to explicitly include citations to such documents and/or explicitly include the functionally corresponding structures which were incorporate by reference above.

Thus, for any invention element(s)/structure(s) corresponding to functional claim limitation(s), in the below claims, that are interpreted under 35 USC § 112(6) (post AIA 112(f)), which is/are not explicitly disclosed in the foregoing patent specification, Applicant(s) have explicitly prescribed which documents and material to include the otherwise missing disclosure, and have prescribed exactly which portions of such patent and/or non-patent documents should be incorporated by such reference for the purpose of satisfying the disclosure requirements of 35 USC § 112 (6). Applicant(s) note that all the identified documents above which are incorporated by reference to satisfy 35 USC § 112 (6) necessarily have a filing and/or publication date prior to that of the instant application, and thus are valid prior documents to incorporated by reference in the instant application.

Having fully described at least one embodiment of the present invention, other equivalent or alternative methods of implementing dog waste management according to the present invention will be apparent to those skilled in the art. Various aspects of the invention have been described above by way of illustration, and the specific embodiments disclosed are not intended to limit the invention to the particular forms disclosed. The particular implementation of the dog waste management may vary depending upon the particular context or application. By way of example, and not limitation, the dog waste management described in the foregoing were principally directed to dog waste management using a wearable bag holder implementations; however, similar techniques may instead be applied to management of waste for any four legged animal or any animal, which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

The corresponding structures, materials, acts, and equivalents of all means or step plus function elements in the claims below are intended to include any structure, material, or act for performing the function in combination with other claimed elements as specifically claimed.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The Abstract is provided to comply with 37 C.F.R. Section 1.72(b) requiring an abstract that will allow the reader to ascertain the nature and gist of the technical disclosure. That is, the Abstract is provided merely to introduce certain concepts and not to identify any key or essential features of the claimed subject matter. It is submitted with the understanding that it will not be used to limit or interpret the scope or meaning of the claims.

The following claims are hereby incorporated into the detailed description, with each claim standing on its own as a separate embodiment.

What is claimed is:

1. A system comprising:
a pet harness device, wherein said pet harness device is configured to encircle the pet's body and fastened to secure the pet harness device to the pet's body;
a waste bag mechanism, wherein said waste bag mechanism is configured to attach to said pet harness device, and wherein said waste bag mechanism is operable for collecting pet waste;
a front strap component disposed on a proximate front end portion of said pet harness device, in which said front strap component comprises a front male fastening device;
a front female fastening device, wherein said front female fastening device is configured to engage said front male fastening device to generally engage said harness waste device on the pet's body;
a waste bag retention tab implement disposed on a proximate rear-end portion of said pet harness device, wherein said waste bag retention tab is operable for attaching said waste bag mechanism; and
a rear leg strap implement into engagement with said waste bag retention tab implement, in which said rear leg strap implement comprises a proximate rear length adjustable leg strap implement, wherein said rear length adjustable leg strap implement is configured to keep said waste bag mechanism in place or open whichever body or leg positions the pet may be in.

2. The system of claim 1, further comprising a waste bag concealing cover, wherein said waste bag concealing cover is configured to conceal said waste bag mechanism.

3. The system of claim 2, in which said waste bag concealing cover comprises a waste bag concealing cover opening, wherein said waste bag concealing cover opening is configured to allow a pet's tail through.

4. The system of claim 3, further comprising a rear length adjustable leg strap cover implement.

5. The system of claim 4, further comprising a male closure device disposed at an end portion of said rear leg strap implement.

6. The system of claim 5, in which said rear length adjustable leg strap implement comprises:
a left rear length adjustable leg strap; and
a right rear length adjustable leg strap.

7. The system of claim 6, in which said waste bag retention tab implement comprises:
a left rear leg waste bag retention tab; and
a right rear leg waste bag retention tab, wherein said left rear leg waste bag retention tab and said right rear leg waste bag retention tab are configured to keep an attached waste bag mechanism.

8. The system of claim 7, in which said waste bag mechanism comprises a semi-rigid re-sealable lining near a waste bag opening, wherein said lining is configured to keep an attached waste bag mechanism open and seal said waste bag mechanism in a closed position after the pet's waste has been deposited in the waste bag mechanism.

9. The system of claim 5, in which said male closure device disposed at an end portion of said rear length adjustable leg strap implement comprises:
a left rear length adjustable leg strap male closure device; and
a right rear length adjustable leg strap closure device.

10. The system of claim 9, further comprising:
a left female closure device disposed at a proximate left mid-section of said pet harness device, wherein said left female closure device is configured to engage said left rear length adjustable leg strap male closure device; and
a right female closure device disposed at a proximate right mid-section of said pet harness device, wherein said right female closure device is configured to engage said right rear length adjustable leg strap male closure device.

11. The system of claim 4, in which said rear leg strap cover implement comprises:
a left rear length adjustable leg strap cover; and
a right rear length adjustable leg strap cover.

12. The system of claim 10, further comprising a pocket implement, wherein said pocket implement is operable for storing items.

13. The system of claim 11, in which said pocket implement comprises
at least two pockets disposed on a proximate left front section of said pet harness device; and
at least two pockets disposed on a proximate right front section of said pet harness device.

14. The system of claim 1, in which said waste bag is configured to be resealable by employing a sealing and resealing mechanism that is operable to substantially seal said bag when in a closed position and be substantially opened when in an unsealed position.

15. The system of claim 7, in which said waste bag retention tab implement further comprises two sets of a hook and loop fastener.

16. A system comprising:
means for encircling a pet's body to protect the pet in a cold temperature and allow for cooling during a warm temperature;
means for securing said encircling means to said encircling means;
means for collecting a pet waste, where in said pet waste collecting means comprises a removable means for storing the pet waste;
means for attaching said pet waste collecting means to a proximate rear side section of said encircling means;
means for strapping said proximate rear side section of said encircling means around a rear leg of the pet;
means for concealing said pet waste collecting means; and
means for storing items.

17. A system comprising:
a pet harness device, wherein said pet harness device is configured to encircle the pet's body, in which said pet harness device comprises a one-piece breathable mesh garment that is configured to be operable for protecting the pet in a cold temperature and allow for cooling during a warm temperature;
a pocket implement, wherein said pocket implement is operable for storing items, in which said pocket implement comprises at least two pockets disposed on a proximate left front section of said pet harness device and at least two pockets disposed on a proximate right front section of said pet harness device;
a waste bag mechanism, wherein said waste bag mechanism is configured to attach to said pet harness device, and wherein said waste bag mechanism is operable for collecting pet waste;
a front strap component disposed on a proximate front end portion of said pet harness device, in which said front strap component comprises a front male fastening device;
a front female fastening device, wherein said front female fastening device is configured to engage said front male fastening device to generally engage said harness waste device on the pet's body;
a waste bag retention tab implement disposed on a proximate rear-end portion of said pet harness device, wherein said waste bag retention tab is operable for attaching said waste bag mechanism;
a rear length adjustable leg strap implement into engagement with said waste bag retention tab implement, wherein said rear length adjustable leg strap implement is configured to keep said waste bag mechanism in place or open whichever body or leg positions the pet may be in;
a waste bag concealing cover, wherein said waste bag concealing cover is configured to conceal said waste bag mechanism.

18. The system of claim 17, in which said waste bag concealing cover comprises a waste bag concealing cover opening, wherein said waste bag concealing cover opening is configured to allow a pet's tail through.

19. The system of claim 18, further comprising:
a rear length adjustable leg strap cover implement; and
a male closure device disposed at an end portion of said rear length adjustable leg strap implement.

20. The system of claim 19, in which said waste bag retention tab implement comprises:
a left rear leg waste bag retention tab; and
a right rear leg waste bag retention tab, wherein said left rear leg waste bag retention tab and said right rear leg waste bag retention tab are configured to keep an attached waste bag mechanism.
